(19) United States
(12) Patent Application Publication
(10) Pub. No.: US 2025/0158154 A1
(43) Pub. Date: May 15, 2025

(54) ALL-SOLID RECHARGEABLE BATTERY

(71) Applicant: SAMSUNG SDI CO., LTD., Yongin-si (KR)

(72) Inventors: Hyungho KIM, Yongin-si (KR); Jaehwan HA, Yongin-si (KR); Yujin KANG, Yongin-si (KR); Juyun KIM, Yongin-si (KR); Dongho KOO, Yongin-si (KR)

(21) Appl. No.: 18/931,349

(22) Filed: Oct. 30, 2024

(30) Foreign Application Priority Data
Nov. 15, 2023 (KR) 10-2023-0158554
Nov. 15, 2023 (KR) 10-2023-0158555

(51) Int. Cl. H01M 10/653; H01M 10/613; H01M 10/6551; H01M 50/105; H01M 50/211; H01M 50/293

(52) U.S. Cl. CPC H01M 10/653; H01M 10/613; H01M 10/6551; H01M 50/105; H01M 50/211; H01M 50/293

(57) ABSTRACT

An all-solid rechargeable battery includes at least one unit cell having a stack of a negative electrode, a solid electrolyte layer, and a positive electrode, a pouch accommodating the at least one unit cell, and a ceramic heat dissipation layer on at least one surface of the pouch accommodating the at least one unit cell.

### CROSS-REFERENCE TO RELATED APPLICATION

This application claims priority to and the benefit of Korean Patent Application No. 10-2023-0158554, filed in the Korean Intellectual Property Office on Nov. 15, 2023, and Korean Patent Application No. 10-2023-0158555, filed in the Korean Intellectual Property Office on Nov. 15, 2023, the entire contents of which are incorporated herein by reference.

### BACKGROUND

### 1. Field

The present disclosure relates to an all-solid rechargeable battery.

### 2. Description of the Related Art

Recently, in response to industrial demands, the development of batteries with high energy density and safety is being actively conducted. For example, lithium-ion batteries are being put into practical use not only in the fields of information-related devices and communication devices, but also in the automobile field. In the automotive field, they are particularly important because their safe operation helps prevent risks of explosion and fire.

For example, some lithium-ion batteries currently on the market may include electrolytes containing flammable organic solvents, and therefore, may potentially overheat and ignite in the event of a short circuit. In contrast, an all-solid rechargeable battery using a solid electrolyte, instead of an electrolyte solution with a flammable organic solvent, may be desired.

Because the all-solid rechargeable battery does not use a flammable organic solvent, the possibility of fire or explosion in the event of a short circuit may be considerably reduced. Therefore, the all-solid rechargeable battery may considerably increase safety compared to a lithium ion battery using the electrolyte solution.

The above information disclosed in this background section is only for enhancement of understanding of the background of the disclosure, and therefore it may contain information that does not form the prior art that is already known in this country to a person of ordinary skill in the art.

### SUMMARY

Aspects of embodiments provide an all-solid rechargeable battery including at least one unit cell including a stack of a negative electrode, a solid electrolyte layer, and a positive electrode, a pouch accommodating the at least one unit cell, and a ceramic heat dissipation layer on at least one surface of the pouch.

The positive electrode may include a positive electrode current collector in a middle of the at least one unit cell, and a positive electrode active material layer on each opposite surfaces of the positive electrode current collector, the negative electrode may include a negative electrode current collector and a negative electrode active material layer, and the solid electrolyte layer, the negative electrode active material layer, and the negative electrode current collector being sequentially stacked on the positive electrode active material layer on each of the opposite surfaces of the positive electrode current collector.

The ceramic heat dissipation layer may be on an outer surface of the pouch.

The all-solid rechargeable battery may further include an elastic layer on the negative electrode current collector, an inner surface of the pouch being in contact with the elastic layer.

The ceramic heat dissipation layer may be on an inner surface of the pouch.

The all-solid rechargeable battery may further include an elastic layer on the negative electrode current collector, the ceramic heat dissipation layer being in contact with the elastic layer.

The ceramic heat dissipation layer may include one of a two-dimensional hexagonal boron nitride, a cubic boron nitride, a silicon nitride, and an aluminum nitride.

The ceramic heat dissipation layer may be a two-dimensional hexagonal boron nitride layer, the two-dimensional hexagonal boron nitride layer having in-plane thermal conductivity of 550 (W/m·K), an out-of-plane thermal conductivity of 30 (W/m·K), and a specific resistance of 10¹³ to 10¹⁵ (Ω·cm).

The ceramic heat dissipation layer may be a cubic boron nitride layer, the cubic boron nitride layer having a thermal conductivity of 1300 (W/m·K) and a specific resistance of 10² to 10¹⁰ (Ω·cm).

The ceramic heat dissipation layer may be a silicon nitride layer, the silicon nitride layer having a thermal conductivity of 70 (W/m·K) and a specific resistance of 3.16×10¹¹ to 1.73×10¹³ (Ω·cm).

The ceramic heat dissipation layer may be an aluminum nitride layer, the aluminum nitride layer having a thermal conductivity of 140 to 320 (W/m·K) and electrical insulation properties.

Aspects of embodiments also provide an all-solid rechargeable battery including a plurality of unit cells, each of the plurality of unit cells including a stack of a negative electrode, a solid electrolyte layer, and a positive electrode, and a ceramic heat dissipation layer between adjacent ones of the plurality of unit cells.

The positive electrode may include a positive electrode current collector in a middle of each of the plurality of unit cells, and a positive electrode active material layer on each opposite surfaces of the positive electrode current collector, the negative electrode includes a negative electrode current collector and a negative electrode active material layer, and the solid electrolyte layer, the negative electrode active material layer, and the negative electrode current collector being sequentially stacked on the positive electrode active material layer on each of the opposite surfaces of the positive electrode current collector.

The ceramic heat dissipation layer may be on an outer surface of the negative electrode current collector between the plurality of unit cells.

The plurality of unit cells may include a first unit cell, a second unit cell, and a third unit cell stacked sequentially along a stacking direction, and the ceramic heat dissipation layer may be on each of opposite ends of the second unit cell in the stacking direction, the ceramic heat dissipation layer being on an outer surface of the negative electrode current collector on each of the opposite surfaces of the positive electrode current collector.

The positive electrode may include a positive electrode current collector and a positive electrode active material layer, the negative electrode may include a negative electrode current collector and a negative electrode active material layer, and the solid electrolyte layer may be between the negative electrode active material layer and the positive electrode active material layer.

The ceramic heat dissipation layer may be on an outer surface of the positive electrode current collector of one of the plurality of unit cells and on an outer surface of the negative electrode current collector of the one of the plurality of unit cells, the ceramic heat dissipation layer being between the outer surface of the negative electrode current collector of the one of the plurality of unit cells and an outer surface of the positive electrode current collector of an adjacent one of the plurality of unit cells.

The plurality of unit cells may include a first unit cell, a second unit cell, and a third unit cell stacked sequentially along a stacking direction, and the ceramic heat dissipation layer may be on an outer surface of the negative electrode current collector and on an outer surface of the positive electrode current collector of the second unit cell.

### BRIEF DESCRIPTION OF THE DRAWINGS

Features will become apparent to those of skill in the art by describing in detail exemplary embodiments with reference to the attached drawings, in which:

FIG. 1 illustrates a longitudinal cross-sectional view of an all-solid rechargeable battery according to an embodiment.

FIG. 2 illustrates a longitudinal cross-sectional view of the formation of a lithium metal layer of an all-solid secondary battery according to an embodiment.

FIG. 3 illustrates a longitudinal cross-sectional view of an all-solid rechargeable battery according to an embodiment of the present disclosure.

FIG. 4 illustrates a longitudinal cross-sectional view of an all-solid rechargeable battery according to another embodiment of the present disclosure.

FIG. 5 illustrates a longitudinal cross-sectional view of an all-solid rechargeable battery according to yet another embodiment of the present disclosure.

FIG. 6 illustrates a longitudinal cross-sectional view of an all-solid rechargeable battery according to a still another embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” or “above” another layer or substrate, it can be directly on or above the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

In addition, unless explicitly described to the contrary, the word “comprise” and variations such as “comprises” or “comprising” will be understood to imply the inclusion of stated elements but not the exclusion of any other elements.

In addition, “layer” herein includes not only a shape formed on the whole surface when viewed from a plan view, but also a shape formed on a partial surface. Here “or” is not to be construed as an exclusive meaning, and for example, “A or B” is construed to include A, B, A+B, and the like.

### Positive Electrode for All-Solid Rechargeable Battery

In an embodiment, a positive electrode for an all-solid rechargeable battery including a current collector and a positive electrode active material layer disposed on the current collector may be provided, wherein the positive electrode active material layer may include at least one of a positive electrode active material, a sulfide solid electrolyte, a binder, and a conductive material. However, the positive electrode for the all-solid rechargeable battery may include more or less components than the above-described components.

In the embodiment, the positive electrode for the all-solid rechargeable battery may be manufactured by applying a positive electrode composition including at least one of a positive electrode active material, a sulfide solid electrolyte, a binder, and a conductive material to a current collector, followed by drying and roll-pressing.

### Positive Active Material

The positive electrode active material may be applied without limitation as long as it is generally used in all-solid rechargeable batteries. For example, the positive electrode active material may be a compound capable of reversible intercalation and deintercalation of lithium, and may include a compound represented by any one of the following chemical formulas.

LiₐA_{1-b}X_{b}D′₂ (0.90≤a≤1.8, 0≤b≤0.5);

LiₐA_{1-b}X_{b}O_{2-c}D′_{c} (0.90≤a≤1.8, 0≤b≤0.5, 0≤c≤0.05);

LiₐE_{1-b}X_{b}O_{2-c}D′_{c} (0.90≤a≤1.8, 0≤b≤0.5, 0≤c≤0.05);

LiₐE_{2-b}X₆O_{4-c}D′_{c} (0.90≤a≤1.8, 0≤b≤0.5, 0≤c≤0.05);

LiₐNi_{1-b-c}Co_{b}X_{c}D′_{α} (0.90≤a≤1.8, 0≤b≤0.5, 0≤c≤0.5, 0<α≤2);

LiₐNi_{1-b-c}Co_{b}X_{c}O_{2-α}T_{α} (0.90≤a≤1.8, 0≤b≤0.5, 0≤c≤0.05, 0<α<2);

LiₐNi_{1-b-c}Co_{b}X_{c}O_{2-α}T₂ (0.90≤a≤1.8, 0≤b≤0.5, 0≤c≤0.05, 0<α<2);

LiₐNi_{1-b-c}Mn_{b}X_{c}D′_{α} (0.90≤a≤1.8, 0≤b≤0.5, 0≤c≤0.05, 0<α≤2);

LiₐNi_{1-b-c}Mn_{b}X_{c}O_{2-α}T_{α} (0.90≤a≤1.8, 0≤b≤0.5, 0≤c≤0.05, 0<α<2);

LiₐNi_{1-b-c}Mn_{b}X_{c}O_{2-α}T₂ (0.90≤a≤1.8, 0≤b≤0.5, 0≤c≤0.05, 0<α<2);

LiₐNi_{b}E_{c}G_{d}O₂ (0.90≤a≤1.8, 0≤b≤0.9, 0≤c≤0.5, 0.001≤d≤0.1);

LiₐNi_{b}Co_{c}Mn_{d}GₑO₂ (0.90≤a≤1.8, 0≤b≤0.9, 0≤c≤0.5, 0≤d≤0.5, 0.001≤e≤0.1);

LiₐNiG_{b}O₂ (0.90≤a≤1.8, 0.001≤b≤0.1);

LiₐCoG_{B}O₂ (0.90≤a≤1.8, 0.001≤b≤0.1);

LiₐMn_{1-b}G_{b}O₂ (0.90≤a≤1.8, 0.001≤b≤0.1);

LiₐMn₂G_{b}O₄ (0.90≤a≤1.8, 0.001≤b≤0.1);

LiₐMn_{1-g}G_{g}PO₄ (0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂(PO₄)₃ (0≤f≤2);

Li_{(3-f)}Fe₂(PO₄)₃ (0≤f≤2); and

LiₐFePO₄ (0.90≤a≤1.8).

In the above chemical formulas, A may be selected from Ni, Co, Mn, and a combination thereof, X may be selected from Al, Ni, Co, Mn, Cr, Fe, Mg, Sr, V, rare earth elements, and a combination thereof; D′ may be selected from O, F, S, P, and a combination thereof; E may be selected from Co, Mn, and a combination thereof; T may be selected from F, S, P, and a combination thereof; G may be selected from Al, Cr, Mn, Fe, Mg, La, Ce, Sr, V, and a combination thereof; Q may be selected from Ti, Mo, Mn, and a combination thereof; Z may be selected from Cr, V, Fe, Sc, Y, and a combination thereof; and J may be selected from V, Cr, Mn, Co, Ni, Cu, and a combination thereof.

The positive electrode active material may be, e.g., lithium cobalt oxide (LCO), lithium nickel oxide (LNO), lithium nickel cobalt oxide (NC), lithium nickel cobalt aluminum oxide (NCA), lithium nickel cobalt manganese oxide (NCM), and lithium nickel manganese oxide (NM), lithium manganese oxide (LMO), or lithium ferrous phosphate oxide (LFP).

The positive electrode active material may include a lithium nickel oxide represented by Chemical Formula 1 below, a lithium cobalt oxide represented by Chemical Formula 2 below, a lithium ferrous phosphate compound represented by Chemical Formula 3 below, or a combination thereof.

Liₐ₁Niₓ₁M¹_{y1}M²_{1-x1-y1}O₂ [Chemical Formula 1]

In Chemical Formula 1, 0.9≤a1≤1.8, 0.3≤x1≤1, 0≤y1≤0.7, and M¹ and M² may be each one or more elements independently selected from Al, B, Ba, Ca, Ce, Co, Cr, Cu, F, Fe, Mg, Mn, Mo, Nb, P, S, Si, Sr, Ti, V, W, and Zr.

Liₐ₂COₓ₂M³₁₋ₓ₂O₂ [Chemical Formula 2]

In Chemical Formula 2, 0.9≤a2≤1.8, 0.6≤x2≤1, and M³ may be one or more elements selected from Al, B, Ba, Ca, Ce, Cr, Cu, F, Fe, Mg, Mn, Mo, Nb, P, S, Si, Sr, Ti, V, W, and Zr.

Liₐ₃Feₓ₃M⁴₁₋ₓ₃PO₄ [Chemical Formula 3]

In Chemical Formula 3, 0.9≤a3≤1.8, 0.6≤x3≤1, and M⁴ may be one or more elements selected from Al, B, Ba, Ca, Ce, Co, Cr, Cu, F, Fe, Mg, Mn, Mo, Nb, P, S, Si, Sr, Ti, V, W, and Zr.

An average particle diameter (D50) of the positive electrode active material may be 1 μm to 25 μm, e.g., 3 μm to 25 μm, 5 μm to 25 μm, 5 μm to 20 μm, 8 μm to 20 μm, or 10 μm to 18 μm. The positive electrode active material having the above particle diameter range may be harmoniously mixed with other components in the positive electrode active material layer and may implement the high capacity and high energy density.

The positive electrode active material may be in the form of a secondary particle made by agglomeration of a plurality of primary particles, or may be in the form of a single particle. In addition, the positive electrode active material may be spherical or close to a spherical shape, or may be polyhedral or amorphous.

### Sulfide Solid Electrolyte

The sulfide solid electrolyte may include, e.g., Li₁S—P₂S₅, Li₂S—P₂S₅—LiX (X is a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each an integer, and Z is Ge, Zn, or Ga), Li₂S—GeS₂, Li₂S—SiS₂—Li₃PO₄, Li₂S—SiS₂—LiₚMO_{q} (p and q are integers, and M is P, Si, Ge, B, Al, Ga, or In), or a combination thereof.

The sulfide solid electrolyte may be obtained by, e.g., mixing Li₂S and P₂S₅ at a molar ratio of 50:50 to 90:10 or 50:50 to 80:20 and optionally heat treating the mixture. Within the above mixing ratio range, the sulfide solid electrolyte having excellent ionic conductivity may be manufactured. Here, SiS₂, GeS₂, B₂S₃, and the like as other components may be further included to further improve the ionic conductivity.

A mechanical milling or solution method may be applied as a method of mixing sulfur-containing raw materials to prepare the sulfide solid electrolyte. The mechanical milling is a method of particulating and mixing starting materials by putting the starting materials, a ball mill, and the like in a reactor and stirring strongly the mixture. When using the solution method, the solid electrolyte may be obtained as a precipitate by mixing the starting materials in a solvent. In addition, when heat treatment is performed after mixing, crystals of the solid electrolyte may become more robust and the ionic conductivity may be improved. As an example, the sulfide solid electrolyte may be prepared by mixing sulfur-containing raw materials and heat-treating the sulfur-containing raw materials twice. In this case, the sulfide solid electrolyte having high ionic conductivity and robustness may be prepared.

As an example, the sulfide solid electrolyte particles may contain argyrodite type sulfide. The argyrodite type sulfide may be expressed by, e.g., LiₐM_{b}P_{c}S_{d}Aₑ (a, b, c, d, and e all are 0 or more to 12 or less, M may be Ge, Sn, Si, or a combination thereof, and A may be F, Cl, Br, or I). For example, the argyrodite type sulfide may be expressed by Li₇₋ₓPS₆₋ₓAₓ (x is 0.2 or more and 1.8 or less, and A may be F, Cl, Br, or I), e.g., Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or the like.

The sulfide solid electrolyte particles containing such argyrodite type sulfide may have high ionic conductivity close to the range of 10⁻⁴ to 10⁻² S/cm, which is ionic conductivity of a typical liquid electrolyte at room temperature, and may form a tight bond between the positive active material and the solid electrolyte without causing a decrease in the ion conductivity, and further form a tight interface between the electrode layer and the solid electrolyte layer. The all-solid rechargeable battery containing this may improve the performance of the battery, e.g., rate characteristics, coulombic efficiency, and lifespan characteristics.

The argyrodite type sulfide solid electrolyte may be prepared by, e.g., mixing lithium sulfide, phosphorus sulfide, and optionally lithium halide. After mixing them, the heat treatment may be performed. The heat treatment may include, e.g., two or more heat treatment steps.

The average particle size (D50) of the sulfide solid electrolyte particles according to an embodiment may be 5.0 μm or less, e.g., 0.1 μm to 5.0 μm, 0.1 μm to 4.0 μm, 0.1 μm to 3.0 μm, 0.5 μm to 2.0 μm, or 0.1 μm to 1.5 μm. Alternatively, the sulfide solid electrolyte particles may be small particles having the average particle size (D50) of 0.1 μm to 1.0 μm depending on the location or purpose of use, or may be large particles having an average particle size (D50) of 1.5 μm to 5.0 μm. The sulfide solid electrolyte particles in this particle size range may effectively penetrate between the solid particles in the battery, and have excellent contactability with the electrode active material and the connectivity between the solid electrolyte particles. The average particle size of the sulfide solid electrolyte particles may be measured using a microscope image. For example, the particle size distribution may be obtained by measuring the size of about 20 particles in a scanning electron microscope image, and the (D50) may be calculated from the particle size distribution.

The content of the solid electrolyte in the positive electrode for the all-solid rechargeable battery may be 0.5 wt % to 35 wt %, e.g., 1 wt % to 35 wt %, 5 wt % to 30 wt %, and 8 wt % to 25 wt %, or 10 wt % to 20 wt %. This is the content relative to a total weight of the components in the positive electrode (i.e., the wt % of the solid electrolyte is relative to a total weight (100 wt %) of the positive electrode active material layer).

For example, the positive electrode active material layer may contain 50 wt % to 99.35 wt % of positive electrode active material, 0.5 wt % to 35 wt % of sulfide solid electrolyte, 0.1 wt % to 10 wt % of fluorinated resin binder, and 0.05 wt % to 5 wt % of vanadium oxide, based on 100 wt % of positive electrode active material layer. When this content range is satisfied, the positive electrode for the all-solid rechargeable battery maintains high adhesion while maintaining high capacity and high ionic conductivity, and maintains the viscosity of the positive electrode composition at an appropriate level, thereby improving the processability.

### Binder

The binder serves to appropriately bind positive electrode active material particles to each other and appropriately bind the positive electrode active material to the current collector. As a representative example of the binder, polyvinylalcohol, carboxymethylcellulose, hydroxypropylcellulose, diacetylcellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, an epoxy resin, nylon, or the like, may be used.

### Conductive Material

The positive electrode active material layer may further include a conductive material. The conductive material is used to provide conductivity to an electrode, and may include, e.g., a carbon material such as natural graphite, artificial graphite, carbon black, acetylene black, Ketjen black, a carbon fiber, and a carbon nanotube; a metal material in the form of metal powder or metal fiber containing copper, nickel, aluminum, silver, and the like; a conductive polymer such as a polyphenylene derivative; or a combination thereof.

The conductive material may be included in an amount of 0.1 wt % to 5 wt %, e.g., 0.1 wt % to 3 wt %, with respect to a total weight of each component of the positive electrode for an all-solid battery, or with respect to the total weight of the first positive electrode active material layer. Within the above content range, the conductive material can improve electrical conductivity without deteriorating battery performance.

When the positive electrode active material layer further includes a conductive material, the positive electrode active material layer may include 45 wt % to 99.25 wt % of the positive electrode active material, 0.5 wt % to 35 wt % of the sulfide solid electrolyte, 0.1 wt % to 10 wt % of the fluorine resin binder, 0.05 wt % to 5 wt % of the vanadium oxide, and 0.1 wt % to 5 wt % of the conductive material with respect to 100 wt % of the positive electrode active material layer.

Meanwhile, the positive electrode for a lithium rechargeable battery may further include an oxide inorganic solid electrolyte, in addition to the solid electrolyte described above. The oxide inorganic solid electrolyte may include, e.g., Li₁₊ₓTi₂₋ₓAl PO₄₃(LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃ (PLZT) (0≤x<1, 0≤y<1), PB (Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}PO₄₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, garnet ceramics Li₃₊ₓLa₃M₂O₁₂ (M=Te, Nb, or Zr; x is an integer from 1 to 10), or a combination thereof.

### All-Solid Rechargeable Battery

An embodiment provides an all-solid rechargeable battery including the positive electrode described above, a negative electrode, and a solid electrolyte layer positioned between the positive electrode and the negative electrode. The all-solid rechargeable battery may be referred to as an all-solid battery or an all-solid lithium rechargeable battery.

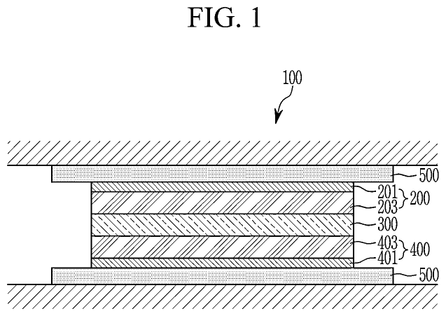

FIG. 1 illustrates a cross-sectional view of an all-solid rechargeable battery according to an embodiment. Referring to FIG. 1, an all-solid rechargeable battery 100 may have a structure in which an electrode assembly, in which a negative electrode 400 including a negative current collector 401 and a negative electrode active material layer 403, a solid electrolyte layer 300, and a positive electrode 200 including a positive electrode active material layer 203 and a positive electrode current collector 201 are stacked, is accommodated in a case, e.g., a pouch. The all-solid rechargeable battery 100 may further include an elastic layer 500 on an outer side of at least one of the positive electrode 200 and the negative electrode 400. Although FIG. 1 shows one electrode assembly including the negative electrode 400, the solid electrolyte layer 300, and the positive electrode 200, an all-solid battery may be manufactured by stacking two or more electrode assemblies.

### Negative Electrode

The negative electrode for an all-solid battery may include, e.g., a current

collector and a negative electrode active material layer disposed on the current collector. The negative electrode active material layer may include a negative electrode active material and may further include a binder, a conductive material, and/or a solid electrolyte.

The negative electrode active material may include a material capable of reversibly intercalation/deintercalating lithium ions, lithium metal, an alloy of lithium metal, a material capable of being doped and undoped on lithium, or a transition metal oxide.

The material capable of reversibly intercalating/deintercalating lithium ions may be a carbon negative electrode active material, e.g., crystalline carbon, amorphous carbon, or a combination thereof. Examples of the crystalline carbon may include graphite such as amorphous, plate-like, flake-like, spherical or fibrous natural graphite or artificial graphite, and examples of the amorphous carbon may include soft carbon or hard carbon, mesophase pitch carbide, fired coke, and the like.

For the alloy of the lithium metal, an alloy of lithium and one or more metal selected from Na, K, Rb, Cs, Fr, Be, Mg, Ca, Sr, Si, Sb, Pb, In, Zn, Ba, Ra, Ge, Al and Sn may be used

For the material capable of being doped or undoped on the lithium, a Si negative electrode active material or an Sn negative electrode active material may be used. Examples of the Si negative electrode active material may include silicon, silicon-carbon composite, SiOₓ (0<x≤2), and a Si-Q alloy (Q may be an element selected from alkali metals, alkali earth metals, Group 13 elements, Group 14 elements, Group 15 elements, Group 16 elements, transition metals, rare-earth elements, and combinations thereof, but is not Si). Examples of the Sn negative electrode active material may include Sn, SnO₂, a Sn—R alloy (R may be an element selected from alkali metals, alkali earth metals, Group 13 elements, Group 14 elements, Group 15 elements, Group 16 elements, transition metals, rare-earth elements, and combinations thereof, but is not Sn). In addition, a mixture of at least one thereof and SiO₂ may be used. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The silicon-carbon composite may be, e.g., a silicon-carbon composite including a core including crystalline carbon and a silicon particle and an amorphous carbon coating layer positioned on a surface of the core. The crystalline carbon may be artificial graphite, natural graphite, or a combination thereof. As the amorphous carbon precursor, coal pitch, mesophase pitch, petroleum pitch, coal oil, petroleum heavy oil, or polymer resin such as phenol resin, furan resin, and polyimide resin may be used. In this case, a content of silicon may be 10 wt % to 50 wt % with respect to a total weight of the silicon-carbon composite. In addition, a content of the crystalline carbon may be 10 wt % to 70 wt % with respect to the total weight of the silicon-carbon composite, and a content of the amorphous carbon may be 20 wt % to 40 wt % with respect to the total weight of the silicon-carbon composite. In addition, a thickness of the amorphous carbon coating layer may be 5 nm to 100 nm.

An average particle diameter (D50) of the silicon particle may be 10 nm to 20 μm, e.g., 10 nm to 500 nm. The silicon particle may be present in an oxidized form, and in this case, an atomic content ratio of Si:O in the silicon particle, which indicates a degree of oxidation, may be 99:1 to 33:67. The silicon particle may be a SiOₓ particle, in which case a range of x in SiOₓ may be greater than 0 and less than 2. Here, the average particle diameter (D50) is measured with a particle size analyzer using a laser diffraction method and refers to a diameter of a particle with a cumulative volume of 50% by volume in the particle size distribution.

The Si negative electrode active material or Sn negative electrode active material may be used by mixing with a carbon negative electrode active material. A mixing ratio of the Si negative electrode active material or Sn negative electrode active material and the carbon negative electrode active material may be 1:99 to 90:10 at a weight ratio.

The content of the negative electrode active material in the negative electrode active material layer may be 95 wt % to 99 wt % with respect to the total weight of the negative electrode active material layer.

In an embodiment, the negative electrode active material layer may further include a binder, and optionally, may further include a conductive material. The content of the binder in the negative electrode active material layer may be 1 wt % to 5 wt % with respect to the total weight of the negative electrode active material layer. In addition, when a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to adhere the negative electrode active material particles to each other well and also to adhere the negative electrode active material to the current collector well. The binder may include a water-insoluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

Examples of the water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluoro rubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a thickener capable of imparting viscosity may be used together, and the thickener may include, e.g., a cellulose compound. The cellulose compound may include carboxymethyl cellulose, hydroxypropylmethyl cellulose, methyl cellulose, alkali metal salts thereof, or a combination thereof. As the alkali metal, Na, K, or Li may be used. An amount of the thickener used may be 0.1 to 3 parts by weight with respect to 100 parts by weight of the negative electrode active material.

The conductive material is used to provide conductivity to an electrode, and may include, e.g., a carbon material such as natural graphite, artificial graphite, carbon black, acetylene black, Ketjen black, a carbon fiber, and a carbon nanotube; a metal material in the form of metal powder or metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state battery may be a precipitation-type negative electrode. The precipitation-type negative electrode refers to a negative electrode which does not include a negative electrode active material during assembling of a battery but in which lithium metal or the like is precipitated during charging of the battery and serves as a negative electrode active material.

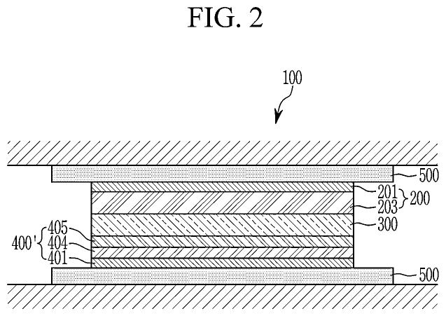

FIG. 2 illustrates a schematic cross-sectional view of an all-solid rechargeable battery including a precipitation-type negative electrode according to an embodiment. Referring to FIG. 2, a precipitation-type negative electrode 400′ may include the negative current collector 401 and a negative electrode coating layer 405 disposed on the current collector. In an all-solid battery having the precipitation-type negative electrode 400′, initial charging begins in the absence of a negative electrode active material, and during the charging, lithium metal with a high density or the like is precipitated between the negative current collector 401 and the negative electrode coating layer 405 and forms a lithium metal layer 404, which can serve as a negative electrode active material. Accordingly, in an all-solid battery that has been charged once or more, the precipitation-type negative electrode 400′ may include the negative current collector 401, the lithium metal layer 404 disposed on the current collector, and the negative electrode coating layer 405 disposed on the metal layer. The lithium metal layer 404 refers to a layer of lithium metal or the like precipitated during the charging process of the battery and may be called a metal layer or a negative electrode active material layer.

The negative electrode coating layer 405 may include metal, a carbon material, or a combination thereof that serves as a catalyst.

The metal may include, e.g., gold, platinum, palladium, silicon, silver, aluminum, bismuth, tin, zinc, or a combination thereof, and may be composed of one selected therefrom or an alloy of more than one thereof. When the metal is present in the form of a particle, an average particle diameter (D50) thereof may be about 4 μm or less, e.g., 10 nm to 4 μm.

The carbon material may be, e.g., crystalline carbon, amorphous carbon, or a combination thereof. The crystalline carbon may be, e.g., natural graphite, artificial graphite, a mesophase carbon microbead, or a combination thereof. The amorphous carbon may be, e.g., carbon black, activated carbon, acetylene black, Denka black, Ketjen black, or a combination thereof.

When the negative electrode coating layer 405 includes both the metal and the carbon material, a mixing ratio of the metal and the carbon material may be, e.g., 1:10 to 2:1 at a weight ratio. In this case, the precipitation of lithium metal can be effectively promoted and the characteristics of the all-solid-state battery can be improved. The negative electrode coating layer 405 may include, e.g., a carbon material on which catalyst metal is supported, or a mixture of metal particles and carbon material particles.

The negative electrode coating layer 405 may include, e.g., the metal and amorphous carbon, and in this case, the precipitation of lithium metal may be effectively promoted.

The negative electrode coating layer 405 may further include a binder, and the binder may be a conductive binder. Furthermore, the negative electrode coating layer 405 may further include general additives such as a filler, a dispersant, and an ion conductive material.

A thickness of the negative electrode coating layer 405 may be, e.g., 100 nm to 20 μm, 500 nm to 10 μm, or 1 μm to 5 μm.

For example, the precipitation-type negative electrode 400′ may further include a thin film on the surface of the current collector, i.e., between the current collector and the negative electrode coating layer. The thin film may contain an element that can form an alloy with lithium. The element that can form an alloy with lithium may be, e.g., gold, silver, zinc, tin, indium, silicon, aluminum, bismuth, and the like, which may be used alone or as an alloy of more than one thereof. The thin film can further planarize a precipitation shape of the lithium metal layer 404 and further improve the characteristics of the all-solid battery. The thin film may be formed by, e.g., a vacuum deposition method, a sputtering method, a plating method, or the like. The thin film may have, e.g., a thickness ranging from 1 nm to 500 nm.

### Solid Electrolyte Layer

The solid electrolyte layer 300 may include a sulfide solid electrolyte, an oxide solid electrolyte, and the like. The specific description of the sulfide solid electrolyte and the oxide solid electrolyte are the same as above.

In one example, the solid electrolyte included in the positive electrode 200 and the solid electrolyte included in the solid electrolyte layer 300 may include the same compound or different compounds. For example, if both the positive electrode 200 and the solid electrolyte layer 300 include an argyrodite-type sulfide solid electrolyte, the overall performance of the all-solid rechargeable battery may be improved. Furthermore, as an example, if both the positive electrode 200 and the solid electrolyte layer 300 include the coated solid electrolyte described above, the all-solid rechargeable battery may implement excellent initial efficiency and life characteristics while implementing a high capacity and a high energy density.

Meanwhile, the average particle diameter (D50) of the solid electrolyte included in the positive electrode 200 may be smaller than the average particle diameter (D50) of the solid electrolyte included in the solid electrolyte layer 300. In this case, the overall performance can be improved by maximizing the energy density of the all-solid-state battery and increasing the mobility of lithium ions. For example, the average particle diameter (D50) of the solid electrolyte included in the positive electrode 200 may be 0.1 μm to 1.0 μm, e.g., 0.1 μm to 0.8 μm, and the average particle diameter (D50) of the solid electrolyte included in the solid electrolyte layer 300 may be 1.5 μm to 5.0 μm, e.g., 2.0 μm to 4.0 μm or 2.5 μm to 3.5 μm. When the above particle diameter ranges are satisfied, the energy density of the all-solid rechargeable battery is maximized and the transfer of lithium ions is facilitated, making it possible to suppress resistance and thus to improve the overall performance of the all-solid rechargeable battery. Here, the average particle diameter (D50) of the solid electrolyte may be measured with a particle size analyzer using a laser diffraction method. Alternatively, a particle size distribution may be obtained by measuring sizes of about 20 particles selected from a microscope image such as a scanning electron microscope, and a (D50) value may be calculated from the particle size distribution.

The solid electrolyte layer may further include a binder, in addition to the solid electrolyte. In this case, for the binder, a styrene butadiene rubber, polytetrafluoroethylene, polyvinylidene fluoride, polyethylene, an acrylate polymer, or a combination thereof may be used, and any binder used in the art may be used. The acrylate polymer may be, e.g., butyl acrylate, polyacrylate, polymethacrylate, or a combination thereof.

The solid electrolyte layer may be formed by adding a solid electrolyte to a binder solution, coating a base film with the solution, and drying the resultant. The solvent for the binder solution may be isobutyryl isobutyrate, xylene, toluene, benzene, hexane, or a combination thereof.

A thickness of the solid electrolyte layer may be, e.g., 10 μm to 150 μ. The solid electrolyte layer may further include an alkali metal salt, and/or an

ionic liquid, and/or a conductive polymer.

The alkali metal salt may be, e.g., a lithium salt. A content of the lithium salt in the solid electrolyte layer may be 1 M or more, e.g., 1 M to 4 M. In this case, the lithium salt may improve ionic conductivity by improving lithium ion mobility in the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato)borate (LiDFOB), lithium bis(trifluoro methanesulfonyl)imide, LiTFSI, LiN(SO₂CF₃)₂), lithium bis(fluorosulfonyl)imide LiFSI, LiN(SO₂F)₂), LiCF₃SO₃, LiAsF₆, LiSbF₆, LiClO₄, or a mixture thereof.

Furthermore, the lithium salt may be an imide salt. For example, the imide lithium salt may include lithium bis(trifluoro methanesulfonyl)imide, LiTFSI, LiN(SO₂CF₃)₂), lithium bis(fluorosulfonyl)imide, LiFSI, LiN(SO₂F)₂). The lithium salt may maintain or improve ionic conductivity by appropriately maintaining chemical reactivity with an ionic liquid.

The ionic liquid refers to a salt or a room temperature molten salt that has a melting point equal to or lower than a room temperature, is in a liquid state at room temperature and is composed of only ions.

The ionic liquid may be a compound including a) one or more cations selected from ammonium, pyrrolidinium, pyridinium, pyrimidinium, imidazolium, piperidinium, pyrazolium, oxazolium, pyridazinium, phosphonium, sulfonium, and triazolium cations and a mixture thereof, and b) BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)2N—, (C₂F₅SO₂)(CF₃SO₂)N—, and (CF₃SO₂)₂N—

The ionic liquid may be, e.g., one or more selected from N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, e.g., 10:90 to 90:10, 20:80 to 90:10, 30:70 to 90:10, 40:60 to 90:10, or 50:50 to 90:10. The solid electrolyte layer that satisfies the above ranges can maintain or improve ionic conductivity by improving the electrochemical contact area with the electrode. Accordingly, the energy density, discharge capacity, rate characteristics, and the like of the all-solid battery may be improved.

The all-solid battery may include a unit cell having a structure of a positive electrode/a solid electrolyte layer/a negative electrode, a bi-cell structure having a structure of a positive electrode/a solid electrolyte layer/a negative electrode/a solid electrolyte layer/a positive electrode, or a stacked battery in which a structure of a unit battery is repeated.

A shape of the all-solid-state battery may be, e.g., a coin shape, a button shape, a sheet shape, a stack shape, a cylindrical shape, a flat shape, or the like. In addition, the all-solid battery may also be applied to large-sized batteries used in electric vehicles, and the like. For example, the all-solid battery may also be used in a hybrid vehicle such as a plug-in hybrid electric vehicle (PHEV). Furthermore, it may be used in fields that require a large amount of power storage, e.g., may also be used to an electric bicycle, an electric tool or the like.

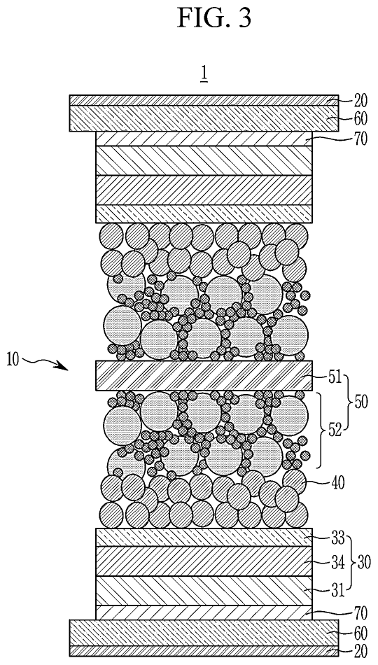

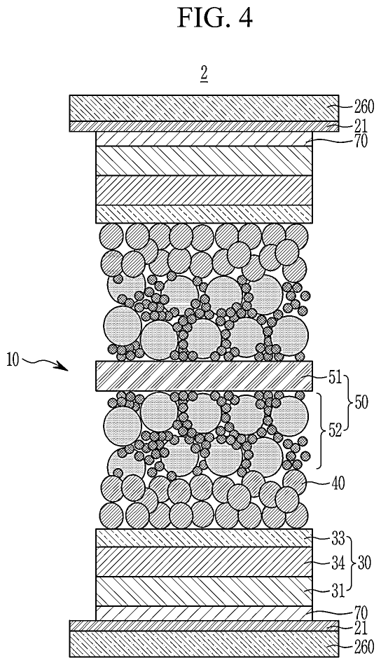

Hereinafter, an all-solid rechargeable battery according to embodiments will be described with reference to FIG. 3 and FIG. 4.

FIG. 3 illustrates a longitudinal cross-sectional view of an all-solid rechargeable battery according to an embodiment of the present disclosure.

Referring to FIG. 3, an all-solid rechargeable battery 1 may include a unit cell 10, a pouch 60, and a ceramic heat dissipation layer 20. The unit cell 10 may be formed by stacking a negative electrode 30, a solid electrolyte layer 40, and a positive electrode 50. The all-solid rechargeable battery 1 in FIG. 3 may be formed by stacking one or more unit cells 10 formed in a bi-cell structure.

The unit cell 10 may be formed by including the positive electrode 50 in the middle of the stacking direction, the solid electrolyte layer 40 on each of the upper and lower sides of the positive electrode 50, and the negative electrode 30 on each solid electrolyte layer 40. The positive electrode 50 may include a positive electrode current collector 51 and a positive electrode active material layer 52 stacked on both surfaces thereof. The negative electrode 30 may include a negative electrode current collector 31 and a negative electrode active material layer stacked on both surfaces thereof.

Therefore, the unit cell 10 may be formed by disposing the positive electrode current collector 51 in the middle of the stacking direction, and sequentially stacking the positive electrode active material layer 52, the solid electrolyte layer 40, the negative electrode active material layer, and the negative electrode current collector 31 on each of opposite surfaces of the positive electrode current collector 51.

As shown in FIG. 3, if the negative electrode 30 is a precipitation-type negative electrode, it may include a negative electrode coating layer 33 disposed on the negative electrode current collector 31. Initial charging begins in the absence of a negative electrode active material, and during the charging, lithium metal with a high density or the like is precipitated between the negative electrode current collector 31 and the negative electrode coating layer 33 and forms a lithium metal layer 34, which may serve as a negative electrode active material layer.

Accordingly, in an all-solid battery that has been charged once or more, the precipitation-type negative electrode 30 may include the negative electrode current collector 31, the lithium metal layer 34 disposed on the negative electrode current collector 31, and the negative electrode coating layer 33 disposed on the lithium metal layer 34. The lithium metal layer 34 refers to a layer of lithium metal or the like precipitated during the charging process of the battery and may be called a metal layer or a negative electrode active material layer.

The all-solid rechargeable battery 1 may further include an elastic layer 70 attached to the negative electrode current collector 31. The elastic layer 70 may be stacked on the outermost portion of the unit cell 10 to buffer volume changes of the unit cell 10 during charging and discharging. The elastic layer 70 may have a compressive strength in a set range.

The pouch 60 may accommodate the unit cell 10 and the elastic layer 70 to form the appearance of the all-solid rechargeable battery 1, e.g., the pouch 60 may accommodate and embed a plurality of unit cells 10. The ceramic heat dissipation layer 20 may be disposed on one surface of the pouch 60, performs heat dissipation if heat is generated from the unit cell 10, and effectively lowers the temperature of the unit cell 10.

In an embodiment, the ceramic heat dissipation layer 20 may be formed on the outer surface of the pouch 60 (e.g., the ceramic heat dissipation layer 20 may be an outermost layer of the all-solid rechargeable battery 1). The ceramic heat dissipation layer 20 may be formed of a sheet and attached to the outer surface of the pouch 60 or may be formed by coating (e.g., the ceramic heat dissipation layer 20 may continuously cover and overlap the entire outer surface of the pouch 60 that faces away from the positive electrode 50). In this case, the inner surface of the pouch 60 may be in contact with the elastic layer 70 (e.g., so the pouch 60 may be between the ceramic heat dissipation layer 20 and the elastic layer 70), and the elastic layer 70 may be attached to the negative electrode current collector 31 of the unit cell 10.

For example, the ceramic heat dissipation layer 20 may be formed by coating one of two-dimensional hexagonal boron nitride (h-BN), cubic boron nitride (c-BN), silicon nitride (Si₃N₄), and aluminum nitride (AlN).

The hexagonal boron nitride (h-BN) has an in-plane thermal conductivity of 550 (W/m·K), an out-of-plane thermal conductivity of 30 (W/m·K), and a specific resistance of 10¹³ to 10¹⁵ (Ω·cm). The cubic boron nitride (c-BN) has a thermal conductivity of 1300 (W/m·K) and a specific resistance of 10² to 10¹⁰ (Ω·cm) . The silicon nitride (Si₃N₄) has a thermal conductivity of 70 (W/m·K) and a specific resistance of 3.16×10¹¹ to 1.73×10¹³ (Ω·cm). The aluminum nitride (AlN) has a thermal conductivity of 140 to 320 (W/m·K) and electrical insulation properties.

The thermal conductivity refers to the ability of a material to transmit thermal energy from one position in space to another. The SI unit of thermal conductivity is W/m·K. The measurement of thermal conductivity may be performed according to various domestic and international standards and experimental methods, including ISO 8301, ISO 8302, ASTM C518, ASTM C1113, KS L 1604, and the like.

The specific resistance is a physical quantity that represents the degree to which a material interferes with the flow of current. The SI unit of the specific resistance is Ω·cm. The measurement of specific resistance may be performed according to various domestic and international standards and experimental methods, including ASTM A717, ASTM D257, KS L 1619, KS L 1620, KS L 2109, KS C IECTS62607-4-3, and the like.

The domestic and foreign standard measurement method of each of the thermal conductivity and the specific resistance is illustrated. It is not necessary to use the above measurement method, and the above measurement method is described as an example. The present disclosure is not limited to the above-described measuring method as long as it is suitable for measuring powder or coating layer.

If heat is generated in the unit cell 10, the ceramic heat dissipation layer 20 dissipates heat transmitted through the elastic layer 70 and the pouch 60 to the outside of the all-solid rechargeable battery 1, so that the heat of the unit cell 10 is dissipated, thereby effectively lowering the temperature of the unit cell 10. In addition, the ceramic heat dissipation layer 20 provides electrical insulation to prevent short circuits between the positive electrode 50 and the negative electrode 30 to perform dissipation heat, thereby preventing thermal runaway.

FIG. 4 illustrates a longitudinal cross-sectional view of an all-solid rechargeable battery according to another embodiment of the present disclosure.

Referring to FIG. 4, in an all-solid rechargeable battery 2, a ceramic heat dissipation layer 21 may be formed on an inner surface of a pouch 260. The ceramic heat dissipation layer 21 may be formed of a sheet and attached to the inner surface of the pouch 260 or may be formed by coating. In this case, the inner surface of the ceramic heat dissipation layer 21 may be in contact with the elastic layer 70, and the elastic layer 70 may be attached to the negative electrode current collector 31 of the unit cell 10. For example, the ceramic heat dissipation layer 21 may be directly between the inner surface of the pouch 260 and the elastic layer 70.

For example, the ceramic heat dissipation layer 21 may be formed by coating one of two-dimensional hexagonal boron nitride (h-BN), cubic boron nitride (c-BN), silicon nitride (Si₃N₄), and aluminum nitride (AlN).

If heat is generated in the unit cell 10, the ceramic heat dissipation layer 21 transmits the heat to the pouch 260 through (e.g., from) the elastic layer 70 to dissipate the heat from the pouch 260 to the outside so that the heat of the unit cell 10 is dissipated, thereby effectively lowering the temperature of the unit cell 10. In addition, the ceramic heat dissipation layer 21 provides electrical insulation to prevent short circuits between the positive electrode 50 and the negative electrode 30 to perform dissipation heat, thereby preventing thermal runaway.

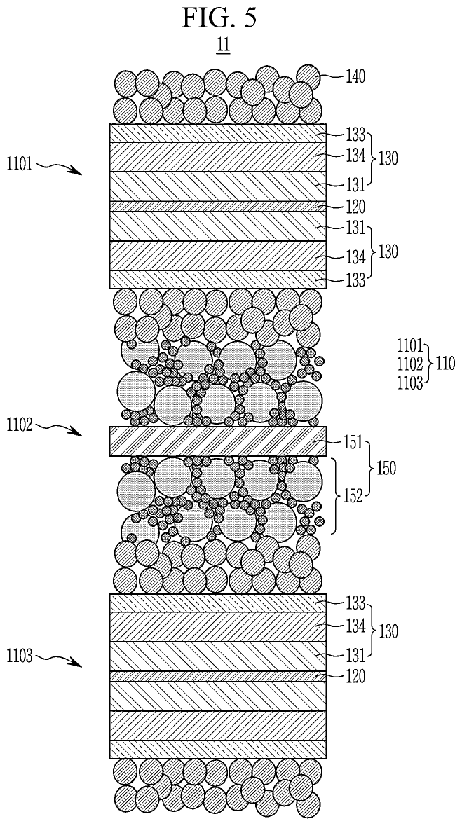

FIG. 5 illustrates a longitudinal cross-sectional view of an all-solid rechargeable battery according to another embodiment of the present disclosure.

Referring to FIG. 5, an all-solid rechargeable battery 11 may include unit cells 110 and a ceramic heat dissipation layer 120. Each of the unit cells 110 may be formed by stacking a negative electrode 130, a solid electrolyte layer 140, and a positive electrode 150. The all-solid rechargeable battery 11 in FIG. 5 may be formed by stacking a plurality of unit cells 110 formed in a bi-cell structure.

The unit cell 110 may be formed by including the positive electrode 150 in the middle of the stacking direction, the solid electrolyte layer 140 on each of the upper and lower sides of the positive electrode 150, and the negative electrode 130 in the solid electrolyte layer 140, e.g., on each of the solid electrolyte layers 140. The positive electrode 150 may include a positive electrode current collector 151 and a positive electrode active material layer 152 stacked on opposite, e.g., both, surfaces thereof. The negative electrode 130 may include a negative electrode current collector 131 and a negative electrode active material layer stacked on opposite, e.g., both, surfaces thereof.

Therefore, the unit cell 110 may be formed by disposing the positive electrode current collector 151 in the middle of the stacking direction and sequentially stacking the positive electrode active material layer 152, the solid electrolyte layer 140, the negative electrode active material layer, and the negative electrode current collector 131 on each of both surfaces thereof.

As shown in FIG. 5, if the negative electrode 130 is a precipitation-type negative electrode, it may include a negative electrode coating layer 133 disposed on the negative electrode current collector 131. Initial charging begins in the absence of a negative electrode active material, and during the charging, lithium metal with a high density or the like is precipitated between the negative electrode current collector 131 and the negative electrode coating layer 133 and forms a lithium metal layer 134, which may serve as a negative electrode active material layer.

Accordingly, in an all-solid rechargeable battery that has been charged once or more, the precipitation-type negative electrode 130 may include the negative electrode current collector 131, a lithium metal layer 134 disposed on the negative electrode current collector 131, and the negative electrode coating layer 133 disposed on the lithium metal layer 134. The lithium metal layer 134 refers to a layer of lithium metal or the like precipitated during the charging process of the battery and may be called a metal layer or a negative electrode active material layer.

In the all-solid rechargeable battery 11, the ceramic heat dissipation layer 120 may be disposed between the unit cells 110, so that if heat is generated in the unit cells 110 adjacent to each other in the stacking direction, the ceramic heat dissipation layer 120 may dissipate heat, thereby effectively lowering the temperatures of the unit cells 110.

In the embodiment of FIG. 5, the ceramic heat dissipation layer 120 is formed on the outer surfaces of the negative electrode current collectors 131 between the unit cells 110. The ceramic heat dissipation layer 120 may be formed of a sheet and attached to the outer surfaces of the negative electrode current collectors 131 or may be formed by coating.

For example, the ceramic heat dissipation layer 120 may be formed by coating one of two-dimensional hexagonal boron nitride (h-BN), cubic boron nitride (c-BN), silicon nitride (Si₃N₄), and aluminum nitride (AlN).

The hexagonal boron nitride (h-BN) has an in-plane thermal conductivity of 550 (W/m·K), an out-of-plane thermal conductivity of 30 (W/m·K), and a specific resistance of 10¹³ to 10¹⁵ (Ω·cm). The cubic boron nitride (c-BN) has a thermal conductivity of 1300 (W/m·K) and a specific resistance of 10² to 10¹⁰ (Ω·cm). The silicon nitride (Si₃N₄) has a thermal conductivity of 70 (W/m·K) and a specific resistance of 3.16×10¹¹ to 1.73×10¹³ (Ω·cm). The aluminum nitride (AlN) has a thermal conductivity of 140 to 320 (W/m·K) and electrical insulation properties.

The thermal conductivity refers to the ability of a material to transmit thermal energy from one position in space to another. The SI unit of thermal conductivity is W/m.K. The measurement of thermal conductivity may be performed according to various domestic and international standards and experimental methods, including ISO 8301, ISO 8302, ASTM C518, ASTM C1113, KS L 1604, and the like.

The specific resistance is a physical quantity that represents the degree to which a material interferes with the flow of current. The SI unit of the specific resistance is Ω·cm. The measurement of specific resistance may be performed according to various domestic and international standards and experimental methods, including ASTM A717,ASTM D257, KS L 1619, KS L 1620, KS L 2109, KS C IECTS62607-4-3, and the like.

The domestic and foreign standard measurement method of each of the thermal conductivity and the specific resistance is illustrated. It is not necessary to use the above measurement method, and the above measurement method is described as an example. The present disclosure is not limited to the above-described measuring method as long as it is suitable for measuring powder or coating layer.

If heat is generated in the unit cells 110 adjacent to each other in the stacking direction, the ceramic heat dissipation layer 120 dissipates heat transmitted through the negative electrode current collectors 131 of the unit cells 110 to the outside for heat dissipation of the unit cells 110, thereby effectively lowering the temperature of the unit cells 110. In addition, the ceramic heat dissipation layer 120 provides electrical insulation to prevent short circuits between the positive electrode 150 and the negative electrode 130 to perform dissipation heat, thereby preventing thermal runaway.

Referring to FIG. 5, the unit cells 110 may include a first unit cell 1101, a second unit cell 1102, and a third unit cell 1103 that are stacked. One of the two ceramic heat dissipation layers 120 may be disposed between the first unit cell 1101 and the second unit cell 1102 to dissipate heat transmitted through the negative electrode current collectors 131 and 131 facing each other to the outside, and the other of the two ceramic heat dissipation layers 120 may be disposed between the second unit cell 1102 and the third unit cell 1103 to dissipate heat transmitted through the negative electrode current collectors 131 and 131 facing each other to the outside.

As described above, because each of the ceramic heat dissipation layers 120 performs heat dissipation between the first and second unit cells 1101 and 1102 and the second and third unit cells 1102 and 1103, the temperature of the entire unit cells 110 may be effectively lowered.

In addition, the ceramic heat dissipation layer 120 provides electrical insulation to prevent short circuits between the positive electrode 150 and the negative electrode 130 in the first, second, and third unit cells 1101, 1102, and 1103 to perform heat dissipation, thereby preventing thermal runaway.

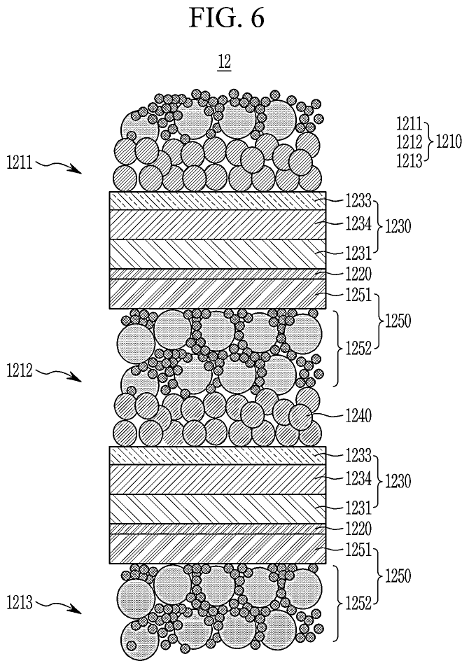

FIG. 6 illustrates a longitudinal cross-sectional view of an all-solid rechargeable battery according to another embodiment.

Referring to FIG. 6, in an all-solid rechargeable battery 12, each of unit cells 1210 may include a solid electrolyte layer 1240 on one side of a positive electrode 1250, and a negative electrode 1230 on the solid electrolyte layer 1240, e.g., the solid electrolyte layer 1240 nay be between the positive electrode 1250 and the negative electrode 1230. The positive electrode 1250 may include a stack of a positive electrode current collector 1251 and a positive electrode active material layer 1252. The negative electrode 1230 may include a stack of a negative electrode current collector 1231, a lithium metal layer 1234 that acts as a negative electrode active material layer stacked on one surface thereof, and a negative electrode coating layer 1233.

Therefore, each of the unit cells 1210 acts as the positive electrode active material layer 1252, the solid electrolyte layer 1240, the negative electrode coating layer 1233, and the negative electrode active material layer are stacked on one side of the positive electrode current collector 1251, and it may be formed by sequentially stacking the lithium metal layer 1234 and the negative electrode current collector 1231 in which deposition of lithium metal is also formed during charging.

The unit cells 1210 may be stacked in the direction of stacking the negative electrode 1230, the solid electrolyte layer 1240, and the positive electrode 1250. At least two unit cells 1210 may be formed to be disposed adjacent to each other.

In the all-solid rechargeable battery 12, the ceramic heat dissipation layer 1220 may be disposed between the unit cells 1210, so that if heat is generated in the unit cells 1210 adjacent to each other in the stacking direction, the ceramic heat dissipation layer 1220 may dissipate heat, thereby effectively lowering the temperatures of the unit cells 1210.

In the embodiment of FIG. 6, the ceramic heat dissipation layer 1220 may be formed on the outer surface of the positive electrode current collector 1251 of one neighboring unit cell 1210 among the unit cells 1210 and the outer surface of the negative electrode current collector 1231 of the other neighboring unit cells 1210. The ceramic heat dissipation layer 1220 may be formed as a sheet and installed in a structure attached to at least one of the outer surface of the positive electrode current collector 1251 and the outer surface of the negative electrode current collector 1231, or may be formed by coating on at least one side thereof.

For example, the ceramic heat dissipation layer 1220 may be formed by coating one of two-dimensional hexagonal boron nitride (h-BN), cubic boron nitride (c-BN), silicon nitride (Si₃N₄), and aluminum nitride (AlN).

If heat is generated in the unit cells 1210 adjacent to each other in the stacking direction, the ceramic heat dissipation layer 1220 dissipates heat transmitted through the positive electrode current collector 1251 and the negative electrode current collector 1231 of the unit cells 1210 to the outside for heat dissipation of the unit cells 1210, thereby effectively lowering the temperature of the unit cells 1210. In addition, the ceramic heat dissipation layer 1220 provides electrical insulation to prevent short circuits between the positive electrode 1250 and the negative electrode 1230 to perform dissipation heat, thereby preventing thermal runaway.

Referring to FIG. 6, the unit cells 1210 may include a first unit cell 1211, a second unit cell 1212, and a third unit cell 1213 that are stacked. One of the two ceramic heat dissipation layers 1220 is disposed between the first unit cell 1211 and the second unit cell 1212 to dissipate heat transmitted through the negative electrode current collector 1231 and the positive electrode current collector 1251 facing each other to the outside, and the other of the two ceramic heat dissipation layers 1220 may be disposed between the second unit cell 1212 and the third unit cell 1213 to dissipate heat transmitted through the negative electrode current collector 1231 and the positive electrode current collector 1251 facing each other to the outside.

As described above, because each of the ceramic heat dissipation layers 1220 performs heat dissipation between the first and second unit cells 1211 and 1212 and the second and third unit cells 1212 and 1213, the temperature of the entire unit cells 1210 may be effectively lowered.

In addition, the ceramic heat dissipation layer 1220 provides electrical insulation to prevent short circuits between the positive electrode 1250 and the negative electrode 1230 in the first, second, and third unit cells 1211, 1212, and 1213 to perform heat dissipation, thereby preventing thermal runaway.

By way of summation and review, embodiments provide an all-solid rechargeable battery that may improve heat dissipation performance,. That is, embodiments provide an all-solid rechargeable battery that may effectively lower the temperature by performing heat dissipation, e.g., in a single unit cell or between unit cells, if (e.g., when) heat is generated.

In embodiments, a ceramic heat dissipation layer is provided in the pouch of the all-solid rechargeable battery, e.g., directly on a surface of the pouch and/or between unit cells adjacent to each other in the stacking direction, thereby providing heat dissipation if heat is generated in a unit cell or between unit cells, thereby effectively lowering the temperature of the unit cells.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An all-solid rechargeable battery, comprising:
at least one unit cell including a stack of a negative electrode, a solid electrolyte layer, and a positive electrode;
a pouch accommodating the at least one unit cell; and
a ceramic heat dissipation layer on at least one surface of the pouch.

2. The all-solid rechargeable battery as claimed in claim 1, wherein:
the positive electrode includes a positive electrode current collector in a middle of the at least one unit cell, and a positive electrode active material layer on each opposite surfaces of the positive electrode current collector,
the negative electrode includes a negative electrode current collector and a negative electrode active material layer, and
the solid electrolyte layer, the negative electrode active material layer, and the negative electrode current collector being sequentially stacked on the positive electrode active material layer on each of the opposite surfaces of the positive electrode current collector.

3. The all-solid rechargeable battery as claimed in claim 2, wherein the ceramic heat dissipation layer is on an outer surface of the pouch.

4. The all-solid rechargeable battery as claimed in claim 3, further comprising an elastic layer on the negative electrode current collector, an inner surface of the pouch being in contact with the elastic layer.

5. The all-solid rechargeable battery as claimed in claim 2, wherein the ceramic heat dissipation layer is on an inner surface of the pouch.

6. The all-solid rechargeable battery as claimed in claim 5, further comprising an elastic layer on the negative electrode current collector, the ceramic heat dissipation layer being in contact with the elastic layer.

7. The all-solid rechargeable battery as claimed in claim 1, wherein the ceramic heat dissipation layer includes one of a two-dimensional hexagonal boron nitride, a cubic boron nitride, a silicon nitride, and an aluminum nitride.

8. The all-solid rechargeable battery as claimed in claim 7, wherein the ceramic heat dissipation layer is a two-dimensional hexagonal boron nitride layer, the two-dimensional hexagonal boron nitride layer having in-plane thermal conductivity of 550 (W/m·K), an out-of-plane thermal conductivity of 30 (W/m·K), and a specific resistance of 10¹³ to 10¹⁵ (Ω·cm).

9. The all-solid rechargeable battery as claimed in claim 7, wherein the ceramic heat dissipation layer is a cubic boron nitride layer, the cubic boron nitride layer having a thermal conductivity of 1300 (W/m·K) and a specific resistance of 10² to 10¹⁰ (Ω·cm).

10. The all-solid rechargeable battery as claimed in claim 7, wherein the ceramic heat dissipation layer is a silicon nitride layer, the silicon nitride layer having a thermal conductivity of 70 (W/m·K) and a specific resistance of 3.16×10¹¹ to 1.73×10¹³ (Ω·cm).

11. The all-solid rechargeable battery as claimed in claim 7, wherein the ceramic heat dissipation layer is an aluminum nitride layer, the aluminum nitride layer having a thermal conductivity of 140 to 320 (W/m·K) and electrical insulation properties.

12. An all-solid rechargeable battery, comprising:
a plurality of unit cells, each of the plurality of unit cells including a stack of a negative electrode, a solid electrolyte layer, and a positive electrode; and
a ceramic heat dissipation layer between adjacent ones of the plurality of unit cells.

13. The all-solid rechargeable battery as claimed in claim 12, wherein:
the positive electrode includes a positive electrode current collector in a middle of each of the plurality of unit cells, and a positive electrode active material layer on each opposite surfaces of the positive electrode current collector,
the negative electrode includes a negative electrode current collector and a negative electrode active material layer, and
the solid electrolyte layer, the negative electrode active material layer, and the negative electrode current collector being sequentially stacked on the positive electrode active material layer on each of the opposite surfaces of the positive electrode current collector.

14. The all-solid rechargeable battery as claimed in claim 13, wherein the ceramic heat dissipation layer is on an outer surface of the negative electrode current collector between the plurality of unit cells.

15. The all-solid rechargeable battery as claimed in claim 13, wherein:
the plurality of unit cells include a first unit cell, a second unit cell, and a third unit cell stacked sequentially along a stacking direction, and
the ceramic heat dissipation layer is on each of opposite ends of the second unit cell in the stacking direction, the ceramic heat dissipation layer being on an outer surface of the negative electrode current collector on each of the opposite surfaces of the positive electrode current collector.

16. The all-solid rechargeable battery as claimed in claim 12, wherein:
the positive electrode includes a positive electrode current collector and a positive electrode active material layer,
the negative electrode includes a negative electrode current collector and a negative electrode active material layer, and
the solid electrolyte layer is between the negative electrode active material layer and the positive electrode active material layer.

17. The all-solid rechargeable battery as claimed in claim 16, wherein the ceramic heat dissipation layer is on an outer surface of the positive electrode current collector of one of the plurality of unit cells and on an outer surface of the negative electrode current collector of the one of the plurality of unit cells, the ceramic heat dissipation layer being between the outer surface of the negative electrode current collector of the one of the plurality of unit cells and an outer surface of the positive electrode current collector of an adjacent one of the plurality of unit cells.

18. The all-solid rechargeable battery as claimed in claim 16, wherein:
the plurality of unit cells include a first unit cell, a second unit cell, and a third unit cell stacked sequentially along a stacking direction, and
the ceramic heat dissipation layer is on an outer surface of the negative electrode current collector and on an outer surface of the positive electrode current collector of the second unit cell.
